(19) United States
(12) Patent Application Publication
(10) Pub. No.: US 2007/0116617 A1
(43) Pub. Date: May 24, 2007

(54) Exhaust treatment device comprising lock-seam and methods of assembling the same

(76) Inventors: Michael Paul Lawrukovich, Flushing, MI (US); Gary F. Stack, Linden, MI (US)

Correspondence Address: Paul L. Marshall;Delphi Technologies, Inc., M/C 480-410-202, P.O. Box 5052, Troy, MI, 48007, US

(21) Appl. No.: 11/285,571

(22) Filed: Nov. 21, 2005

(51) Int. Cl. B01D 53/34

(52) U.S. Cl. 422/179

(57) ABSTRACT

Disclosed herein are exhaust treatment devices comprising a lock-seam and methods of assembling the same. In one embodiment, the exhaust treatment device comprises: a substrate, a mat disposed around the substrate, and an upstream shell half and a downstream shell half disposed around the mat. The upstream shell half and the downstream shell half are connected by a lock-seam that is disposed between an upstream face and a downstream face of the mat. In one embodiment, the method for producing an exhaust treatment device comprises: assembling a mat around a substrate to form a substrate/mat sub-assembly, disposing an upstream shell half and a downstream shell half around the substrate/mat sub-assembly, and forming a lock-seam that connects the upstream shell half to the downstream shell half such that the lock-seam is disposed between and upstream end and a downstream end of the mat.

### TECHNICAL FIELD

This disclosure generally relates to exhaust treatment devices and methods of assembling the same.

### BACKGROUND

Exhaust treatment devices such as, catalytic converters, particulate filters, NOx adsorbers (“NOx traps”), selective catalytic reduction (SCR) substrates, and the like, have demonstrated success at reducing the amount of undesirable emissions that are discharged from internal combustion engines. These devices reduce these emissions by catalytically converting the undesirable gases into less undesirable products within a catalytic substrate. Catalytic substrates can be manufactured in many configurations; however can generally comprise catalytic metals disposed on a large surface area to encourage efficient conversion of the exhaust stream.

Although successful at reducing exhaust discharge, catalytic based technologies comprise a high overall device cost. The high cost is primarily due to the cost of manufacturing the intricate catalytic substrates and the cost of the catalysts disposed thereon. Furthermore, the high cost of these devices is acerbated by recently instituted exhaust treatment device efficiency requirements that are more stringent than the previous requirements. To meet these requirements, device manufacturers are investing additional funds into researching and developing more efficient devices, which essentially is passed on to the consumer.

In an effort to contain costs, manufacturers are innovating more flexible and cost efficient means of manufacturing. In addition to making efforts to reduce costs from the higher cost components (e.g., substrate, catalysts), efforts are also being made to reduce lower-priced component costs and assembly costs. One such innovation is disclosed herein that provides for a more cost effective and flexible assembly process.

### BRIEF SUMMARY

Disclosed herein are exhaust treatment devices and methods of assembly. In one embodiment, the exhaust treatment device comprises: a substrate, a mat disposed around the substrate, and an upstream shell half and a downstream shell half disposed around the mat. The upstream shell half and the downstream shell half are connected by a lock-seam that is disposed between an upstream face and a downstream face of the mat.

In one embodiment, the method for producing an exhaust treatment device comprises: assembling a mat around a substrate to form a substrate/mat sub-assembly, disposing an upstream shell half and a downstream shell half around the substrate/mat sub-assembly, and forming a lock-seam that connects the upstream shell half to the downstream shell half such that the lock-seam is disposed between and upstream end and a downstream end of the mat.

The above described and other features are exemplified by the following figures and detailed description.

### BRIEF DESCRIPTION OF THE DRAWINGS

Refer now to the figures, which are exemplary embodiments, and wherein the like elements are numbered alike.

FIG. 1 is a cross-sectional illustration of an exemplary exhaust treatment device.

FIG. 2 is a partial cut-away cross-sectional illustration of an exemplary upstream flange and a downstream flange.

FIG. 3 is a partial cut-away cross-sectional illustration of exemplary configurations of an upstream flange and a downstream flange.

FIG. 4a-4d are cross-sectional illustrations of exemplary lock-seam configurations.

FIG. 5a-5b are cross-sectional illustrations of exemplary lock-seam configurations comprising a living hinge.

FIG. 6 is a partial, cross-sectional side view of an exemplary lock seam comprising an exemplary sealing element.

FIG. 7 is a partial, cross-sectional side view of an exemplary lock seam comprising another exemplary sealing element.

### DETAILED DESCRIPTION

Disclosed herein are methods of assembling exhaust treatment devices. More specifically, a method of assembling an exhaust treatment device shell is disclosed that employs a lock-seam, e.g., instead of welding. In the specific embodiments disclosed, it is envisioned that sealant will not be required as the lock seam will be disposed downstream (in exhaust direction) from a retention matting configuration that can prevent exhaust leakage.

The terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item. The suffix “(s)” as used herein is intended to include both the singular and the plural of the term that it modifies, thereby including one or more of that term (e.g., the fastener(s) includes one or more fasteners).

Exhaust treatment devices can comprise a housing in which a substrate is supported using substrate retention matting. A catalyst (e.g., platinum, palladium, rhodium, ruthenium, and the like) can be disposed on the substrate to enable the device to convert undesirable gaseous components of the exhaust stream into less undesirable products. To achieve high conversion efficiency, substrates are generally designed to provide a large surface area with which the exhaust stream can react. Some configurations of substrates can be, but are not limited to, foils, preforms, fibrous materials, porous glasses, glass sponges, foams, pellets, particles, molecular sieves, and the like. However, monolith designs are readily employed because they provide high surface area, allow for easy assembly, and provide predictable performance. Monolith substrate designs can comprise a plurality of axially aligned channels that extend from an upstream end to a downstream end (with respect to exhaust stream flow) of the substrate. Furthermore, the channels can be configured in an efficient cross-sectional geometry that maximizes surface area, such as, but not limited to, polygonal shapes (e.g., “honeycomb-like” hexagons, squares, and the like), however channels with any cross-sectional shape can theoretically be employed. Many materials can be employed for the substrate, however materials capable of withstanding elevated operating temperatures from about 600° Celsius, in underfloor applications, and up to about 1,000° Celsius, in manifold mounted or close-coupled applications, can be utilized. Acceptable materials comprise, but are not limited to, cordierite, silicon carbides, metal oxides, and the like.

The housing is employed to support the substrate and direct exhaust fluids through the substrate. The housing generally comprises an outer “shell” that can be tubular in design, comprising any cross-sectional area, such as, a circular or elliptical cross-section. The shell can be capped on either end with “end-plates” or funnel-shaped “end-cones” that can reduce the cross-sectional area of the shell to a size that is more compatible for connecting to exhaust conduit. In some embodiments, the end-cone is formed as a part of the shell (e.g., spin-formed). A section of the end-cone, or end-plate, can be configured to connect with exhaust conduit, this section is referred to as a “snorkel”. The housing components can be fabricated of any material(s) capable of withstanding the temperatures endured during use, the corrosive environment in which the device will be subjected, and the wear encountered during operation. Materials successfully employed comprise, ferrous and ferritic metals (e.g., martensitic, ferritic, and austenitic materials), alloys, and the like.

Disposed between the metal shell and the substrate can be retention matting (mat, matting), which can provide support for the substrate therein. Matting materials can comprise, intumescent materials (e.g., a material that comprises vermiculite component, i.e., a component that expands upon the application of heat), non-intumescent materials (e.g., ceramic preforms, ceramic fibers, organic binders, inorganic binders, and the like), as well as combinations comprising at least one of the foregoing materials. Non-intumescent materials include materials such as those sold under the trademarks “NEXTEL” and “INTERAM 1101HT” by the “3M” Company, Minneapolis, Minn., or those sold under the trademark, “FIBERFRAX” and “CC-MAX” by the Unifrax Co., Niagara Falls, N.Y., and the like. Intumescent materials include materials sold under the trademark “INTERAM” by the “3M” Company, Minneapolis, Minn., as well as those intumescent materials which are also sold under the aforementioned “FIBERFRAX” trademark.

In addition to providing support for the substrate, matting can also insulate the substrate and limit heat loss through the metal shell. This is a desirable for the reason that substrates operate most efficiently at elevated temperatures (e.g., above about 500° C.). Matting also provides a malleable layer between the shell and the substrate that can reduce the effects of difference in thermal expansion and provide impact protection. Moreover, matting can prevent the exhaust stream from passing between the substrate and the shell of the device.

The matting, housing, and substrate have been assembled utilizing various methods. One such method is the “stuffing” assembly method. This method generally comprises pre-assembling the mat around the substrate and pushing, or stuffing, the substrate/mat assembly into a shell through a stuffing cone. The stuffing cone serves as an assembly tool, which comprises a hollow cone that can be temporarily connected to one end of shell. At this location, the stuffing cone can be of similar cross-sectional geometry and of equal or smaller cross-sectional area than the shell 6. Along the stuffing cone's length, in a direction away from shell, the cross-sectional geometry can maintain a similar cross-sectional geometry however gradually taper larger in cross-sectional area. It is through this larger end that a substrate/mat sub-assembly can be introduced and advanced. As the substrate/mat sub-assembly is advanced, the mat around the substrate is concentrically compressed about the substrate and is eventually compressed to a point where the substrate/mat sub-assembly can be “stuffed” into shell.

Although the assembly methods above have proven useful, additional innovations in manufacturing are desired to reduce manufacturing costs. More specifically, the assembly methods discussed above employ various welding processes during manufacturing. Although welding can provide a strong, leakage-proof connection, welding processes can be costly due to high equipment costs and relatively lengthy welding process times. As an alternative, a method of assembly is disclosed that employs a lock-seam instead of welding. This method is envisioned to provide manufacturers with higher throughput and lower equipment costs.

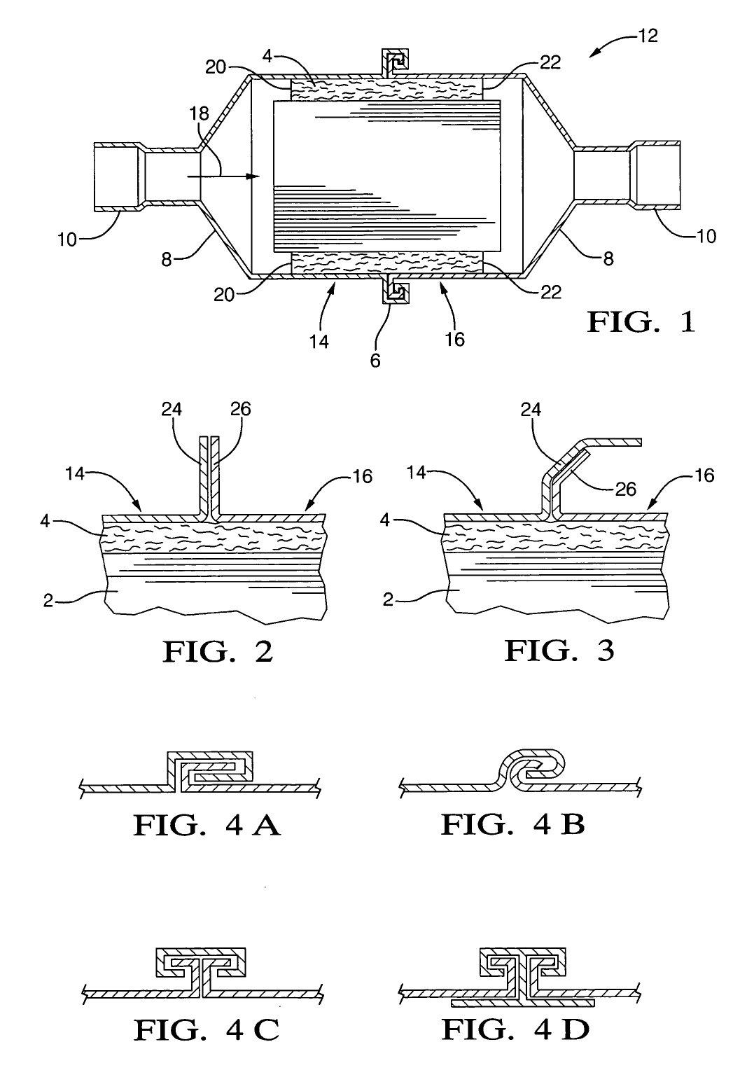

Referring now to FIG. 1, a cross-sectional view of an exemplary exhaust treatment device that is generally designated 12, is illustrated. Exhaust treatment device 12 comprises substrate 2, which is concentrically disposed within a mat 4, wherein mat 4 comprises an upstream face 20 and a downstream face 22. Mat 4 is concentrically disposed within an upstream shell half 14 and a downstream shell half 16, wherein these halves can be assembled together at lock-seam 6. Upstream shell half 14 is connected to an end-cone 8, which is connected to a snorkel 10. As well, downstream shell half 16 is connected to an end-cone 8, which is connected to a snorkel 10. Exhaust stream 18 flows through the device from an upstream direction to a downstream direction.

It is envisioned that either the upstream shell half 14, and/or the downstream shell half 16, can individually comprise an end-cone 8 and snorkel 10 integral to their structure (e.g., using a “spin-form” method), as well as combinations comprising at least one of the housing components. Furthermore, it is to be apparent that the shape of the elements illustrated in FIG. 1 can be of any design, such as, but not limited to cylindrical, tubular, polygonal, conical, and/or irregular geometries.

Exhaust treatment device 12 can be assembled utilizing any method for producing exhaust treatment devices. More specifically, in the embodiment illustrated, it is envisioned that mat 4 is pre-assembled around the substrate 2 to form a substrate/mat subassembly. The substrate/mat subassembly can then be forced into the upstream shell half 14. Thereafter, an assembly support device can be inserted through the upstream snorkel 10, which can contact the substrate 2 and ensure the substrate 2 does not translate as the downstream shell half 16 is pushed onto the portion of the substrate/mat subassembly extending from the upstream shell half 14. Once the downstream shell half 16 is in close proximity to, or in contact with, the upstream shell half 14, a lock-seam 6 can be formed connecting the halves. In another embodiment, the upstream shell half 14 and the downstream shell half 16 can comprise differing lengths so that the lock-seam 6 is disposed off center. For example, upstream shell half 14 can comprise a longer length than the downstream shell half 16. In this embodiment, a stuffing cone can be employed to insert about three-quarters of the substrate/mat subassembly within the upstream shell half 14. Thereafter, the downstream shell half 16 can be pushed onto the portion of the substrate/mat subassembly extending from the upstream shell half 14 without the need to employ an assembly support device to counter-act the assembly forces.

Referring now to FIG. 2, a partial, cut-away cross-sectional illustration depicts that it is envisioned that upstream shell half 14 and downstream shell half 16 can comprise an upstream flange 24 and a downstream flange 26, which can be utilized for forming a lock-seam 6. Although not illustrated, it is to be apparent that the length of the upstream flange 24 and the downstream flange 26 can be of any length that will allow for the forming of a lock-seam 6. Furthermore, it is also to be apparent that these flanges can comprise differing lengths, and/or can be formed into any preliminary configuration, or pre-form, that can provide for increased ease of forming a lock-seam 6 after assembly of the halves. For example, an exemplary embodiment is illustrated in FIG. 3, which illustrates a pre-form of the upstream flange 24 and the downstream flange 26 that can serve as a pre-cursor to the lock-seam 6 illustrated in FIG. 1.

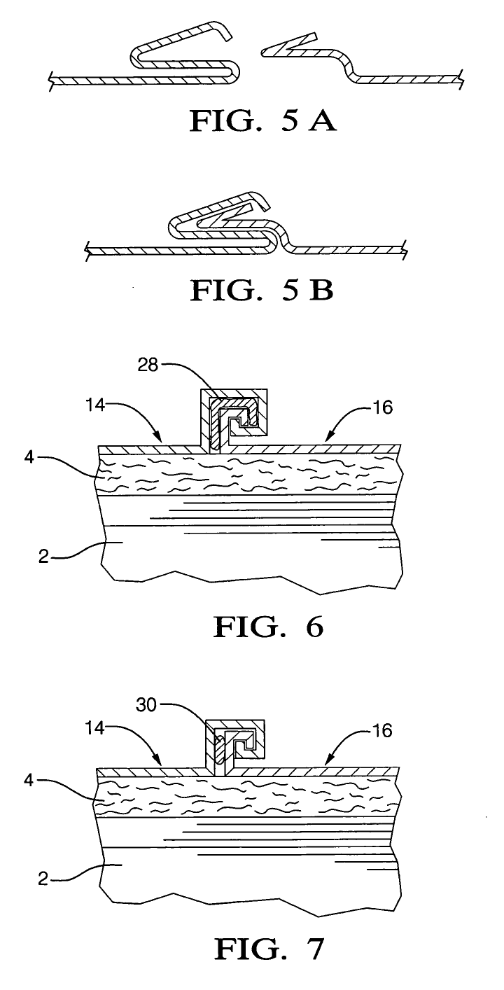

Lock-seam 6 can comprise any geometry that can provide a connection of upstream shell half 14 and downstream shell half 16. Exemplary configurations of lock-seams 6 formed from flanges are illustrated in FIGS. 4a and 4b. It is also envisioned that additional components can be integrated with the flanges or shell halve, as illustrated in FIGS. 4c and 4d. Furthermore, lock-seam 6 can also comprise configurations that can connect the shell halves together in a temporary or permanent connection that employ living hinges, as illustrated in a pre-assembled configuration in FIG. 5a and assembled in FIG. 5b. It is to be apparent that these embodiments are exemplary and illustrate some of the many potential lock-seam 6 configurations, additional configurations encompassed by the essence of the subject matter herein will be apparent to one skilled in the art.

It is desirable that the exhaust treatment device 2 does not leak through the lock-seam 6. It is to be apparent that many, if not all lock-seam 6 designs can be modified in order to improve the features sealing ability. For example, mating flange surfaces can be ground flat prior to assembly to ensure they comprise proper sealing surfaces, the length of the flanges can be increased to provide additional contact area, the forces utilized to form the lock-seal 6 can be adjusted to increase lock-seam's 6 ability to seal, the materials employed for the lock-seam can be modified with more or less malleable materials to increase lock-seam 6 sealing performance, and the like.

The position of the lock-seam 6 can also be repositioned so that the mat 4 can aid in reducing or preventing exhaust leakage. For example, in the embodiment illustrated in FIG. 1, the lock-seam 6 is positioned in the middle of the device. The exhaust pressure at the upstream face 20 is greater than the exhaust pressure at the downstream face 22, therefore, the upstream shell half 14 and the downstream shell half 16 can be reconfigured so that the lock-seam 6 is positioned closer to the downstream face 22 to reduce the potential of exhaust stream 18 leakage. Additionally, the lock-seam 6 can be positioned based upon the type of mat design employed. For example, if the mat 4 is a cylinder with no seams, the lock-seam 6 can be disposed based upon the exhaust pressure considerations. If the mat is a sheet that is wrapped around the substrate 2 (e.g., a tongue and groove mat connection) the lock-seam 6 can be disposed downstream of the intersection of the two ends of the mat. Locating the lock-seam 6 downstream of the intersection of the two ends of the mat enhances the barrier formed in the space between the substrate and shell, thereby preventing exhaust gas passage around the substrate and preventing leakage at the lock-seam 6.

The mat 4 can comprise any configuration that is capable of supporting the substrate 2 within the shell (upstream shell half 14 and downstream shell half 16). More specifically, the mat 4 can comprise a sheet of intumescent material that can be “wrapped” around the substrate 2 prior to assembly. In these designs a seam (not shown) is formed at the joint of the ends of the sheet, which can provide a channel through which the exhaust will attempt to flow. Exhaust pressure from the upstream face 20 decreases as distance from the upstream face 20 increases. Therefore, positioning the lock-seam 6 further from the higher-pressure upstream face 20 can inhibit or reduce the exhaust pressure encountered by the lock-seam 6, and reduce the possibility of exhaust leakage. Furthermore, the sheet's ends can be modified with a pattern (e.g., staggered, stepped, and/or interlocking, and the like) to reduce exhaust leakage through the seam. Moreover, the mat 4 can also comprise designs that do not comprise a seam, such as, but not limited to, a tubular mat perform that can be assembled over a substrate 2. It is apparent that any of the mat 4 configurations specifically discussed, or any not discussed, can be employed to assist in reducing or preventing, a portion, or all, of the exhaust stream 18 from escaping through lock-seam 6. Optionally, an edge of the mat 4 (e.g., the upstream face 20 can comprise sealant(s), rigidizer(s) (e.g., silica), and so forth (e.g., in the form of a coating), to add structural integrity and/or to enhance the mat 4's ability to inhibit exhaust passage round the substrate 2.

Although it is desirable that the lock-seam 6 can prevent exhaust leakage through itself or a combination of the lock-seam 6 and mat 4 can prevent exhaust leakage from the device, it is also envisioned that a sealing element can be employed if desired. The sealing element can comprise any material and any shape that can be employed with, in, or on, the lock seam 6 and/or upstream shell half 14 and/or downstream shell half 16, that can provide a seal capable of preventing exhaust gases from escaping from the exhaust treatment device 2. The sealing element can be a silica, metal (e.g., copper), composite (e.g., graphite fiber, retention matting), a ceramic (e.g., silicon carbide fiber paper), adhesives, and the like, as well as combinations comprising at least one of the foregoing. For example, an exemplary lock-seam 6 comprising a sealing element is illustrated in FIG. 6. In this illustration, a gasket 28 is employed as the sealing element, which is disposed within the lock-seam 6. The lock-seam 6 illustrated can be formed by many methods, such as, disposing the gasket 28 between an upstream flange 24 and a downstream flange 26, and subjecting the assembly to a forming operation. In another example, FIG. 7 illustrates a sealing element that is in the form of an o-ring 30, that can be disposed between the upstream shell half 14 and the down stream shell half 16 prior to assembly to increase the lock-seams 6 sealing ability.

The lock-seam 6 can be formed by any method, such as, but not limited to “metal forming” operations (e.g., punching, swaging, stamping, crimping, peening, forming, melting, welding, and the like), and the like, as well as combinations comprising at least one of the foregoing. Furthermore, any methods can be repeated in any multiplicity, sequence, combination, and/or configuration desired that can produce a desired result. The metal forming methods discussed herein can also employ additional processes or techniques that can assist in forming the desired lock-seam 6. Processes such as, but not limited to, annealing, heat-treating, localized heating, surfacing, grinding, turning, machining, and like processes can be employed. For example, upstream flange 24 and downstream flange 26 can be locally annealed and surfaced on their mating surfaces prior to employing a stamping process that forms a lock-seam 6. In addition, lock-seams 6 can be reinforced using common connecting elements, such as, but not limited to, fastener(s), press-fit(s), screw(s), snap(s), clamp(s), bolt(s), pin(s), dowel(s), rivet(s), and the like.

In summary, exhaust treatment devices comprising a lock-seam and methods of assembling the same are disclosed that are capable of offering device manufacturers additional assembly options. These methods reduce overall production costs by increasing production throughput and reducing the cost of assembly equipment. The design disposes the lock-seam between ends of the mat such that exhaust gas is inhibited exiting the device through the lock-seam. This barrier function is further enhanced by disposing the lock-seam downstream of the intersection of mat ends if the mat is wrapped around the substrate (e.g., a tongue and groove mat configuration).

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An exhaust treatment device, comprising:
a substrate;
a mat disposed around the substrate; and
an upstream shell half and a downstream shell half disposed around the mat, wherein the upstream shell half and the downstream shell half are connected by a lock-seam that is disposed between an upstream face and a downstream face of the mat.

2. The exhaust treatment device of claim 1, wherein the upstream shell half comprises a flange.

3. The exhaust treatment device of claim 1, wherein the downstream shell half comprises a flange.

4. The exhaust treatment device of claim 1, further comprising a sealing element disposed in contact with the upstream shell half and the downstream shell half.

5. The exhaust treatment device of claim 1, wherein the lock-seam comprises a living hinge.

6. The exhaust treatment device of claim 1, wherein the upstream end further comprises a barrier coating.

7. The exhaust treatment device of claim 6, wherein the barrier coating comprises silica.

8. The exhaust treatment device of claim 6, wherein the mat has an intersection of mat ends and wherein the lock-seam is disposed downstream of the intersection.

9. A method for producing an exhaust treatment device, comprising:
assembling a mat around a substrate to form a substrate/mat sub-assembly;
disposing an upstream shell half and a downstream shell half around the substrate/mat sub-assembly; and
forming a lock-seam that connects the upstream shell half to the downstream shell half such that the lock-seam is disposed between and upstream end and a downstream end of the mat.

10. The method of claim 9, further comprising disposing a sealing element in contact with the upstream shell half and/or the downstream shell half prior to forming the lock-seam.

11. The method of claim 9, wherein assembling the mat around the substrate further comprises wrapping the mat around the substrate, wherein mat ends intersect, and wherein the lock-seam is disposed downstream of the intersection.

12. The method of claim 9, further comprising coating an upstream end of the mat with a barrier coating.

13. The method of claim 12, wherein the barrier coating comprises silica.
